(19) United States
(12) Patent Application Publication
(10) Pub. No.: US 2002/0011219 A1
(43) Pub. Date: Jan. 31, 2002

(54) FASTEN DEVICE WITH SPECIAL EL ELEMENTS

(76) Inventor: TSENG-LU CHIEN, TAIPEI HSENG (TW)

Correspondence Address: HOWARD C. MISKIN, C/O STOLL, MISKIN, HOFFMAN & BADIE, EMPIRE STATE BUILDING, 350 FIFTH AVE., STE. 6110, NEW YORK, NY, 10118, US

(21) Appl. No.: 09/304,856

(22) Filed: May 5, 1999

(51) Int. Cl. A62B 35/00

(52) U.S. Cl. 119/859

(57) ABSTRACT

A FASTEN DEVICE WITH EL which for alived animal to wear around anywhere of the body with proper power source to connect with circuit and switch to drive at least one EL elements which MAY selected from Organic EL or Conventional 3D-EL with Proper Ciurcuit to get pre-determined light effects, brightness, duration , functions to get illumination be visible under bad enviroment situation.

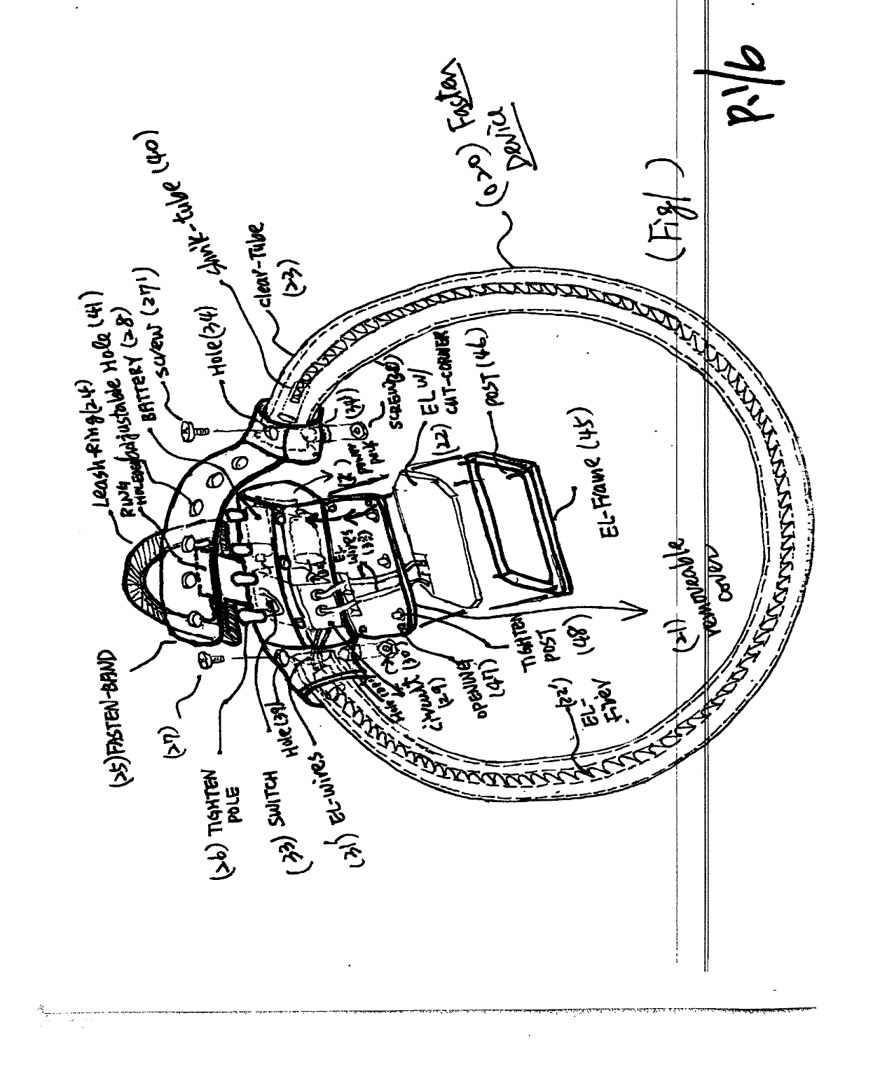

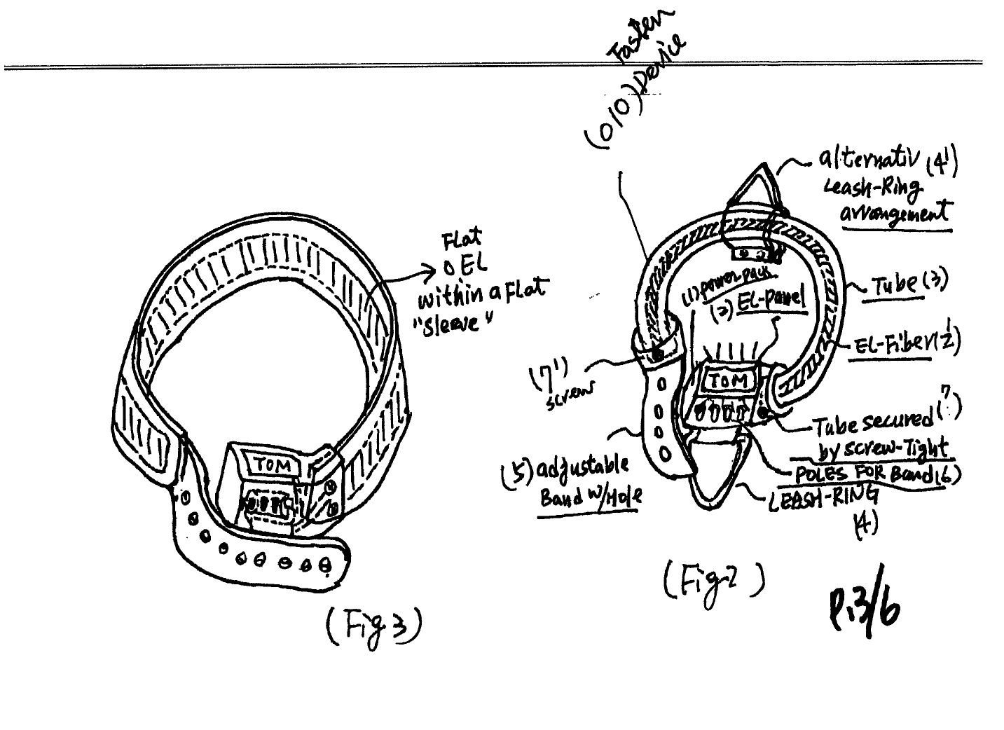

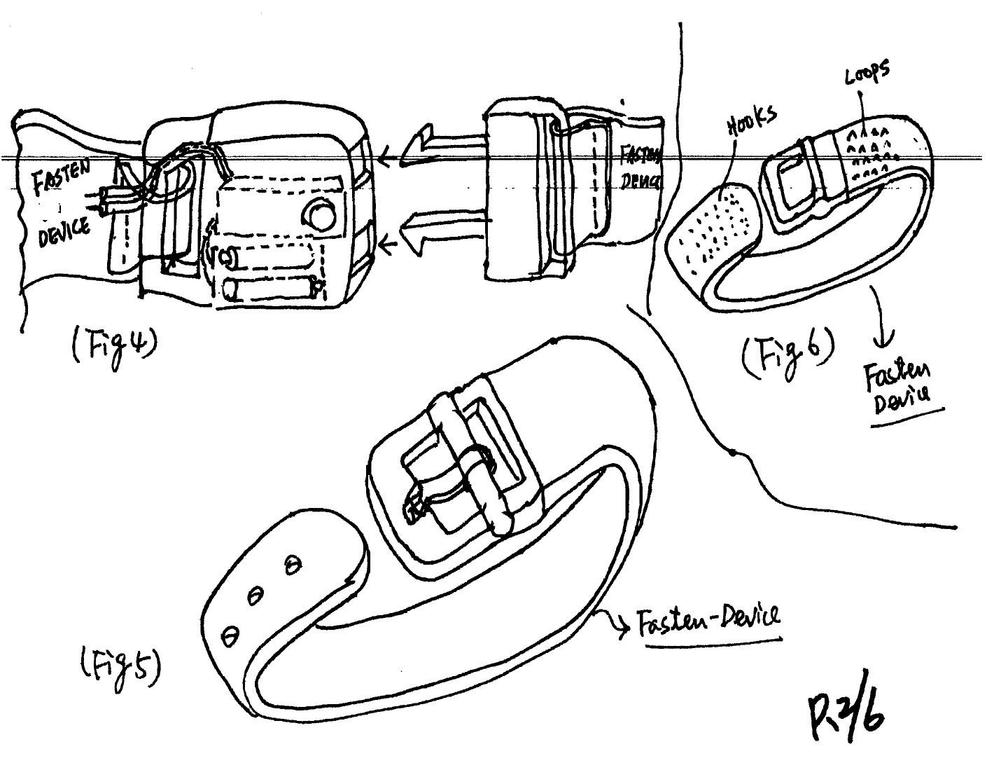

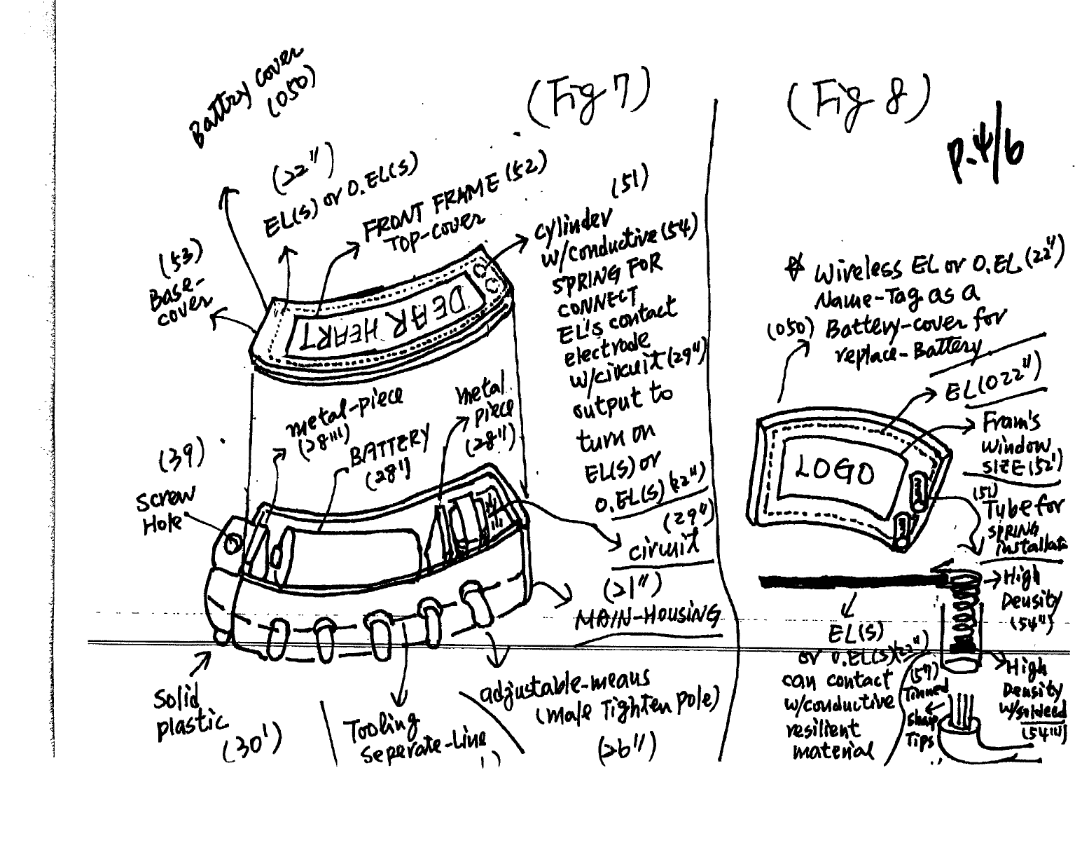

### BACK-GROUD

The U.S. prior art which teach by U.S. Pat. No. 5,370,082 Wade for “Glow In the Dark Animal Collar” use a pularity of illuminating means along the surface of the collar. Wade show on circuitdiagram FIG. (40 and cross referecnec the FIG. (2) and FIG.(3) clear know this is a Light Emitted Diode application which is not practicles for narrow viewing angle of LED light, also the installation a 10 mm unit on a board with collar thickness which is too thick for this application. Easily to broken LED soldering leg by any force applied to LED(s).

The U.S. Pat. No. 5,515,247 Cheung et al disclosure “a electroluminescent strap suitable fro releaseably securing an object to a wrist” which the EL914) are within the Web (2) and connected the power pack on the end inside the buckle member(4).

The inventor's U.S. Pat. No. 5,475,574 filing Apr. 12, 1994 issued Dec. 12, 1995 “Shoulder Strip with an EL strip” AND U.S. Pat. No. 5,469,342 Jan. 25, 19944 filing Nov. 21, 1995 issued “light Strip Apparatus” AND U.S. Pat. No. 5,746,501 Field on Dec. 16, 1996 issued date on May 5, 1998. All have mentioned the EL elements install on a substract material with adjustable means to get prefered tighteness.

However, all the conecpt is use a EL strip or EL panel which do not have disclosure following concept.

a. The current invention using a EL material is a 3 dimensional element(s) which have 10 to 300 degress light beams emitted out.

b. The Priort Arts without any two EL materials on different location for different purpose and under special durable consideratin.

c. The all prior art have to have a AC current to drive EL, The current invention disclosure Organic Electro-luminescent material which can drive by Direct Current so can save a lot of cost for Invertor or the like device.

d. The basic Fasten Device at this current invention with some special arrangement to allow people to add some extra function such as a “ID TAG”/“Pendent Holder”/“Picture Holder” which can incorporated with “Special Arrangement Device” to put other items with it . . .

e. The EL element can use “3D EL” or “Organic EL” to get some featrues for light emitting direction or cost saving for no-invertor needed.

### DETAILS DESCRIPTION

The current invention for a Fasten device with Electro-illuminescent elements which may selected the 3 Dimensional EL element which have features having multiple light emitting direction from a single element so will have a very big viewing angle than traditional 10 EL elements. 3 DEL have a convenient way to get electrodes at any where along the length by simple stripping process which have great advantage to improving existing EL panel with fixed electrodes on ONE LOCATION . . . Hnece, the current invention with 3D EL elements is a great featrues for production without any loss while assembly.

The current invention also disclosure a super brightness EL which DO NOT NEED the any Alternative Current so can save invertor device which may made by transformer, inductor, IC to convert DC to AC for traditional EL element use, Not only the expensive compoment can be saved and also can reduce the dimension for power pack, furtherly the O.EL with a super brightness than any AC-Type EL which almost have hundred to thousand candle power per square meter which is almost 10 to 100 times brighter than AC-TYPE EL elements.

Basing on the 3D EL element(s) and Organic Electro-luminescent (O.EL) will allow the fasten device with much More Durable, Super Brightness, Wider Viewing Angle, Cost Saving, Compact Size for people or animal use for desired light function. This is very important for market place for all these imprvement.

However, The above listed features is not only for fasten device for people or animal use. It also can applied to Product's fasten band such as Backpack, waist bag, shoulder strip, Rope, Delineator line or the like device(s) . . .

From FIG.(1) one of prefered “Fasten Device” (020) with a power pack (21) which have circuit(29), battery(28), switch(33) inside of power pack housing (1) with two ends with two screw opening (39) (39′) allow screw(27) passing though the 1st end of tube (3) and fasten tighterly by lower screw (30). Within the tube(3) there have a 3-D EL elements(22′) are electric connection by two electrodes with circuit by wires(31′)and controlled by circuit (29) to offer the electric signal(s) from power source like battery or batteries(28). The 3D-EL (22′) may have a free-end which are sealed by shrink tube (40) for better enviroment sealing to prevent from moisture or humility get into. The Tube (3) another end are also have two screw hole (34) (34′) to allow screw (27′) to passing though tube and hold by lower screw (30′) so Tube will be tighten on the 2nd ends which with a fasten-Band (25) which have a lot of adjustable hole(40) to hold a lot of number of tighten-pole (26) which on the power pack's (21) one of surface. The another side of surface of power pack with some rigid housing to have proper arrangement for a leash-Ring Holder Device (24) which can hook with Leash's hook or any rope or the like object such as a backpack, waitbag, bicycle bag, garment, Key Chain, ID pass, or other object to allow the Collar become a accessories of objects.

The Circuit(29) will have at least 2 pairs wires sets to build up electric connection for EL's electrodes, battery or batteries's output ends, or another 2nd EL element's electrodes, or the other light-means with number of unit . . . From FIG. (1) the 1st 3 D-EI (22′) is connected with circuit(29) by wires or conductive means (31′). There have a 2nd EI element means (22) which with 4 corner cutted to allow the Frame Holder(45) using its post(46) to press tight fit into hole (47) so the 2nd EL elements can become a ID-Tag or Logo-Tag or address, name, location, speical note on this area to allow people know the message on it ...... This 2nd EL means can use an Organic Electroluminescent elements ( O.EL) (22) for super brightness and directly to operated by a Direct Current such as Battery or Batteries.

Teh Power pack (21) have a removeable cover ( 21′) which can open and close to power pack so battery or batteries can be replaceable easily from this cover. The Cover (21′) may have serveral tighten post (48) to snap into the hole(s) on power pack (21) so it can be easily close and open for battery replacement.

The 2nd EL element may have stencil, logo, name, ID, Address ,masking, silkscreen printing on the EL elements lit-area to form a lighted message to publice be visible.

From the FIG. (2), It is more clear for whole arrangement for Fasten Device with EL-elements which may selected from 3D-EL or Organic EL elements as above features explaination.

The Tube device (3) can be explained as a “Sleeve Constructure” which with same configuration with EL elements such as 3D-EL (2′) (22′) is a tube shape so the sleeve can use a “Clear Tube” or “Partial clear” or “Partial transparent tube” to load the 3D-EI element.

However for the Organic EL element which mainly is a “PANEL” type which can sue a “Flat type Sleeve” to load so it will be much logic match . . . The “Sleeve Means” can be made from an substrate material such as PVC, RUBBER, LEATHER, PLASTIC, PE, PP, PAPER type with a top material stiching togatherly to form a space to allow the “Panel type O.EL” well arranged within this “Sleeve Means”. The Top material also can use sonic, welding, hot seal, glue, velcro, melt to make a sleeve with lower material as above listed type, Top Sleeve can be in all kind marketing material with some arrangement to allow light to be visible from people such as cut-out, transparent, Window, partial clear, all some kinds of opaque as long as people can see the light emitted out from the top material with propoer treatment.

FIG.(3) Show the Flat O.EL panel inside a Flat-Sleeve for a Fasten Device.

FIG. (4) (5) (6) with the other “fasten means” to get the fasten tighten result for variety applications.

FIG. (7) dicsloure the one embodiment of the housing with major compoments installation (Not all) such as Battery cover ( 050) which have a base cover part (53) and Top cover part(52) with front opening window size(52′) which is smaller than underlayed extra EL elements( 22″) and the EI element(s) electrodes is for contact-type which are connected with the Conductive resilient material(54) in this embordiment prefered is a “Metal Spring” which one ends with high density (54″) so can contace EI element(s) electrode and Clipper within this area as FIG.(8). The other end are also high density section ( 54′″) which top end with solered to get solid ends to get electric connection with circuit sharp tips (57) of a wire (58) or circuit output ends.

This arrangement for FIG.(8) can build a replaceable battery cover (050) with Build-in extra EI elements( 22″) by wireless way to get electric connection on each time assembly. This features will allow all extra EL or other device can have much better design and replaceable EL elememtns like a existing home lighting incandescent bulb, PL lamp, halogen bulb without waste other parts . . . This is wireless and replaceable features is not disclousre by any prior arts so this is very unique from this invention. Also, the resilient material with conductivity features also is one of current inventor's U.S. Pat. No. 5,667,394 with more details description but current is not only for electric connection but also for a “REPLACEABLE LIGHT MEANS” features.

Back to FIG. (7) the Battery Cover with Build-in extra EL elements with wireless electric connection arrangement with inner circuit ( 29″) and main housing with a pularity of male tighten poles (26″) with tooing seperated line ( 56) for one of tooling design, it maybe other type of arrangement as marketing skill. The batery (28) here prefered a AAA ALKLINE battery which can be any type of battery as a power source or use any number of battery for life consideration.

The Two or propoer number of metal piece( 28′) (28″) are well arranged for build electricity from powre source to circuit (29). The housing also have a side screw hole (39) to allow screw to passing thoug housing thickness, tube like sleeve thickness and inner solid-material thickness so it will come out from another ends which is almost 180 degree which can use a solid plastic portion (30′) or screw (30) to hold screw with very tighten fasten prevent from loosen. This arragement can very clear to show on FIG. (9) which have a main-housing (21) or adjusta-means (Band's base) (25) with a screw hole (39) to allow screw to passing though Tube (23) thickness and inner solid material (63) with short length just to prevent from Tube-Sleeve do not be pressed and not well passing though by incoming screw (29) fro screw hole(39).

The inventor disclosure a Fasten Devcie with special EL elements with all aboved features which not only as embordiment discription as above listed. Some features also can adapted the same inventor's variety U.S. patent for proper EI arrangemen, Light design, power pack constructure and electric connection methord.

While the invention has been described , disclosed, illustrated and shown in various terms or certain embodiments or modifications which it have assumed in practice, the scope of the invention is not intended to be, nor should it be deemed to be, limited thereby and such other modifications or embordiments as may be suggested by the teachings herein are particularly reserved especially as they fall within the breadth and scope of the claims here appended:

1. A FASTEN DEVICE WITH SPECIAL EL ELEMENT INCORPORATED:
A 3D-Electroluminescent (3D-EL) Elements havig electrodes at any location along the length by simply stripping process.
A invertor device to drive Direct Current power source into Aleternative current signal to turn on 3D-EL element(s) with multiple directions light emitting to be visible.
A power pack housing offer spacing to arrange invertor, power souce, wires, switch, adjust-means, fix-means, extra attachment means, other EL element(s).
The improvement:
At least one 3D-EL element(s) within a Tube-Like Sleeve which have two ends with durable material to allow fix-means to passing though and join togather with two separated piece of adjust-means to change tightenss of device.

2. The Fasten-Device with Special EL elements incorporated:
A Organic Electro-Luminescent (O EL) element(s) within a Sleeve-Device which fixed on a flexible material substract to allow people to visible light emitted out while Elements(s) connected with Direct-Current Power source controlled by circuit and switch for desired illumination, brightness, colors, functions.
The Improvement including:
The two ends of Sleeve Device have its own ajust-means for join togatherly for different tightness.
The power pack can be arranged on desired location on flexible material substract to connect with O.EL element(s) and offer space to arrange circuit, switch, power source, wires, other EL element(s) , extra attachment means.

3. The Fasten-Device with Special EL elements as claim 1 & 2, the extra attachment means including a hook which can hook with Key Chain, Leash, Bag, Name Tag, Picture Holder, Jewery, ID Pass, Music Device, Chemical, Mechanic, Electronic object Combined with Speical EL elements light illumination.

4. The Fasten-Device with Special EL elements as claim 1 & 2, the fix-means may selected from screw, rivit, stitching, melt, sonic, hot sealing, velcro, curved wall for holding tight, to join the adjust-means with sleeve device.

5. The fasten-Device with Special EL elements as claim 1 & 2, the flexible material substract may selected from Paper, Plastic, Leather, Rubber, Textile, Cloth, Woods for durable quality for fasten device.

6. The Fasten-Device with Special EL elements as claim 1 & 2, the fasten device may selected from group consideration of belt, wrist band, necklace, bracelet, arm-band, leg band, head band, collar, alived animal collar, body vest, jogging belt.

7. The Fasten-Device with Special EL elements as claim 1 & 2, The Extra Element can have a wire-less arrangement which use a Conductive Resilient Material may selected desired combination from Metal Spring, Conductive Rubber, Metal Spring material to as a bridge to allow element(s) electrode(s) to connect with circuit output ends to turn on EL element(s).

8. The Fasten Device with Special EL elements as claim 1 & 2, The Power source is battery or batteries which can be replaceable.

9. The Fasten Device with Special EL elements as claim 8, The battery replacement is by a removeable battery cover.

10. The fasten device with special EL elements as claim 8, the removeable battery cover may have extra EL element(s) well arranged on housing.

11. The fasten device with special EL elements as claim 8, The extra elements on replaceable cover can connect with circuit by wire or wireless device.

12. The fasten device with special EL elements as claim 11, The wireless device can apply to at least one extra element(s).

13. The fasten device with special EL elements as claim 1 & 2, The circuit for O.EL do not need invertor constructure and function to transfer the Direct Current to Alterntive current.

14. The Fasten device with special EL elements as claim 1 & 2, The circuit for EL-Fiber may incorporated with invertor device to allow the Direct Current to Alternative current.

15. the fasten device with special EL elements as claim 1 & 2, The circuit for extra EL element(s) may selected propoer design in order to allow extra elements be turned on.

16. The fasten device with special EL elements as claim 1 & 2, The extra Element(s) can have a logo, indicia, design, mark, name, i.D. for marketing requirement.

17. The fasten device with special EL elements as claim 1 & 2, The Housing can be design in desired configuration so allow fasten devie with adjustable means, circle light arrangement, optional extra EL element(s) arrangement and attachment to other products.

18. The fasten device with special EL elements as claim 1,2, The EL-Fiber or O.EL or extra EL elements which can be designed with some lit-area and some non-lit areas by marketing means and connecting methord to become Multiple colors, Multiple Piece, Multiple lit and non-lit arrangement for meet market requirement.

19. The fasten device with special EL elements as claim 18, The EL-Fiber can arrange as in-series ,in paralle, combination of series+parelle by conductive means with desired lit- and non-lit length, color, function, light effects, design consideration.

20. The fasten device with special EL elements as claim 18, the O.EL or extra EL elements can be use coating material technical , discredted arrangement, multiple encapsulation, multiple layers arrangement to get lit-and-nonlit areas, color, function, light effeects , design consideration.

21. The fasten device with special EL elements as claim 1.

22. The fasten device with special EL elements as claim 1.
